(19) United States
(12) Patent Application Publication
(10) Pub. No.: US 2017/0222708 A1
(43) Pub. Date: Aug. 3, 2017

(54) FEEDBACK REPORTING METHOD FOR 3D BEAMFORMING IN WIRELESS COMMUNICATION SYSTEM, AND APPARATUS THEREFOR

(71) Applicant: LG ELECTRONICS INC., Seoul (KR)

(72) Inventors: Jiwon KANG, Seoul (KR); Kitae KIM, Seoul (KR); Kilbom LEE, Seoul (KR); Heejin KIM, Seoul (KR)

(73) Assignee: LG ELECTRONICS INC., Seoul (KR)

(21) Appl. No.: 15/515,112

(22) PCT Filed: Oct. 7, 2015
(86) PCT No.: PCT/KR2015/010630

§ 371 Date: Mar. 28, 2017

Related U.S. Application Data
(60) Provisional application No. 62/061,098, filed on Oct. 7, 2014.

(51) Int. Cl. H04B 7/06; H04W 72/04

(52) U.S. Cl. CPC H04B 7/0639; H04B 7/0617; H04B 7/0632; H04W 72/048; H04W 84/042

(57) ABSTRACT

Disclosed in the present application is a method for a receiving end to report feedback information to a transmitting end in a wireless communication system. Specifically, the method comprises receiving, from a base station, a plurality of reference signals corresponding to a two-dimensional antenna array; determining the number of horizontal antenna ports and the number of vertical antenna ports which reflect the mobility of a receiving end, by using the horizontal channel and the vertical channel estimated based on the plurality of reference signals; calculating a horizontal dimensional control matrix and a vertical dimensional control matrix by using the determined numbers of horizontal antenna ports and vertical antenna ports; determining and reporting a horizontal precoding matrix, a vertical precoding matrix, and a three-dimensional channel link by using the horizontal dimensional control matrix, the vertical dimensional control matrix, the horizontal channel and the vertical channel.

### TECHNICAL FIELD

The present invention relates to a wireless communication system and, more particularly, to a feedback report method and apparatus for three-dimensional (3D) beamforming in a wireless communication system.

### BACKGROUND ART

As an example of a wireless communication system to which the present invention is applicable, a 3rd Generation Partnership Project (3GPP) Long Term Evolution (LTE) communication system will be schematically described.

FIG. 1 is a diagram showing a network structure of an Evolved Universal Mobile Telecommunications System (E-UMTS) as a wireless communication system. The E-UMTS is an evolved form of the UMTS and has been standardized in the 3GPP. Generally, the E-UMTS may be called a Long Term Evolution (LTE) system. For details of the technical specifications of the UMTS and E-UMTS, refer to Release 7 and Release 8 of “3rd Generation Partnership Project; Technical Specification Group Radio Access Network”.

Referring to FIG. 1, the E-UMTS mainly includes a User Equipment (UE), base stations (or eNBs or eNode Bs), and an Access Gateway (AG) which is located at an end of a network (E-UTRAN) and which is connected to an external network. Generally, an eNB can simultaneously transmit multiple data streams for a broadcast service, a multicast service and/or a unicast service.

One or more cells may exist per eNB. The cell is set to use a bandwidth such as 1.25, 2.5, 5, 10, 15 or 20 MHz to provide a downlink or uplink transmission service to several UEs. Different cells may be set to provide different bandwidths. The eNB controls data transmission or reception of a plurality of UEs. The eNB transmits downlink (DL) scheduling information of DL data so as to inform a corresponding UE of time/frequency domain in which data is transmitted, coding, data size, and Hybrid Automatic Repeat and reQest (HARQ)-related information. In addition, the eNB transmits uplink (UL) scheduling information of UL data to a corresponding UE so as to inform the UE of a time/frequency domain which may be used by the UE, coding, data size and HARQ-related information. An interface for transmitting user traffic or control traffic can be used between eNBs. A Core Network (CN) may include an AG, a network node for user registration of the UE, etc. The AG manages mobility of a UE on a Tracking Area (TA) basis. One TA includes a plurality of cells.

Although wireless communication technology has been developed up to Long Term Evolution (LTE) based on Wideband Code Division Multiple Access (WCDMA), the demands and the expectations of users and providers continue to increase. In addition, since other radio access technologies have been continuously developed, new technology evolution is required to secure high competitiveness in the future. Decrease in cost per bit, increase in service availability, flexible use of a frequency band, simple structure, open interface, suitable User Equipment (UE) power consumption and the like are required.

### DISCLOSURE

### Technical Problem

Based on the above-described related art, the present invention is to provide a feedback report method and apparatus for three-dimensional (3D) beamforming in a wireless communication system.

### Technical Solution

The object of the present invention can be achieved by providing a method of, at a reception end, reporting feedback information to a transmission end including receiving a plurality of reference signals corresponding to a two-dimensional antenna array from a base station, estimating a horizontal channel and a vertical channel using the plurality of reference signals, deciding the number of horizontal antenna ports and the number of vertical antenna ports considering mobility of the reception end using the horizontal channel and the vertical channel, calculating a horizontal dimension control matrix and a vertical dimension control matrix using the decided numbers of horizontal antenna ports and vertical antenna ports, deciding ranks of a vertical precoding matrix, a horizontal precoding matrix and a three-dimensional (3D) channel using the horizontal dimension control matrix, the vertical dimension control matrix, the horizontal channel and the vertical channel, and reporting the feedback information including the decided ranks of the vertical precoding matrix, and the horizontal precoding matrix and the 3D channel to the base station.

### Advantageous Effects

According to the embodiments of the present invention, a UE may report more efficient and practical feedback information to an eNB.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

FIG. 1 is a diagram showing a network structure of an Evolved Universal Mobile Telecommunications System (E-UMTS) as an example of a wireless communication system.

FIG. 2 is a diagram showing a control plane and a user plane of a radio interface protocol architecture between a User Equipment (UE) and an Evolved Universal Terrestrial Radio Access Network (E-UTRAN) based on a 3rd Generation Partnership Project (3GPP) radio access network standard.

FIG. 3 is a diagram showing physical channels used in a 3GPP system and a general signal transmission method using the same.

FIG. 4 is a diagram showing the structure of a radio frame used in a Long Term Evolution (LTE) system.

FIG. 5 is a diagram showing the structure of a downlink radio frame used in an LTE system.

FIG. 6 is a diagram showing the structure of an uplink subframe used in an LTE system.

FIG. 7 is a diagram illustrating an antenna tilting scheme.

FIG. 8 is a diagram comparing comparison between an existing antenna system and an active antenna system.

FIG. 9 is a diagram showing an example of forming a UE-specific beam based on an active antenna system.

FIG. 10 is a diagram showing a 3-dimensional (3D) beam transmission scenario based on an active antenna system.

FIG. 11 is a diagram showing comparison in beam coverage between an existing MIMO transmission scheme and a BA beamforming scheme.

FIG. 12 is a diagram showing the concept of a DA beamforming scheme.

FIG. 13 is a diagram showing the features of a DA beamforming scheme.

FIG. 14 is a diagram showing the concept of a DBA beamforming scheme.

FIG. 15 is a diagram showing the concept of a downlink MIMO transmission structure according to an embodiment of the present invention.

FIGS. 16 and 17 are diagrams showing examples of configuring CSI-RS resources configuring an eCSI-RS according to an embodiment of the present invention.

FIG. 18 is a block diagram of a communication apparatus according to one embodiment of the present invention.

### BEST MODE

The configuration, operation and other features of the present invention will be understood by the embodiments of the present invention described with reference to the accompanying drawings. The following embodiments are examples of applying the technical features of the present invention to a 3rd Generation Partnership Project (3GPP) system.

Although, for convenience, the embodiments of the present invention are described using the LTE system and the LTE-A system in the present specification, the embodiments of the present invention are applicable to any communication system corresponding to the above definition. In addition, although the embodiments of the present invention are described based on a Frequency Division Duplex (FDD) scheme in the present specification, the embodiments of the present invention may be easily modified and applied to a Half-Duplex FDD (H-FDD) scheme or a Time Division Duplex (TDD) scheme.

In addition, in the present specification, the term “base station” may include a remote radio head (RRH), an eNB, a transmission point (TP), a reception point (RP), a relay, etc.

FIG. 2 shows a control plane and a user plane of a radio interface protocol between a UE and an Evolved Universal Terrestrial Radio Access Network (E-UTRAN) based on a 3GPP radio access network standard. The control plane refers to a path used for transmitting control messages used for managing a call between the UE and the network. The user plane refers to a path used for transmitting data generated in an application layer, e.g., voice data or Internet packet data.

A physical (PHY) layer of a first layer provides an information transfer service to a higher layer using a physical channel. The PHY layer is connected to a Medium Access Control (MAC) layer located on a higher layer via a transport channel. Data is transported between the MAC layer and the PHY layer via the transport channel. Data is also transported between a physical layer of a transmitting side and a physical layer of a receiving side via a physical channel. The physical channel uses a time and a frequency as radio resources. More specifically, the physical channel is modulated using an Orthogonal Frequency Division Multiple Access (OFDMA) scheme in downlink and is modulated using a Single-Carrier Frequency Division Multiple Access (SC-FDMA) scheme in uplink.

A Medium Access Control (MAC) layer of a second layer provides a service to a Radio Link Control (RLC) layer of a higher layer via a logical channel. The RLC layer of the second layer supports reliable data transmission. The function of the RLC layer may be implemented by a functional block within the MAC. A Packet Data Convergence Protocol (PDCP) layer of the second layer performs a header compression function to reduce unnecessary control information for efficient transmission of an Internet Protocol (IP) packet such as an IPv4 packet or an IPv6 packet in a radio interface having a relatively small bandwidth.

A Radio Resource Control (RRC) layer located at the bottom of a third layer is defined only in the control plane and is responsible for control of logical, transport, and physical channels in association with configuration, re-configuration, and release of Radio Bearers (RBs). The RB is a service that the second layer provides for data communication between the UE and the network. To accomplish this, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A Non-Access Stratum (NAS) layer located above the RRC layer performs functions such as session management and mobility management.

Downlink transport channels for transmission of data from the network to the UE include a Broadcast Channel (BCH) for transmission of system information, a Paging Channel (PCH) for transmission of paging messages, and a downlink Shared Channel (SCH) for transmission of user traffic or control messages. Traffic or control messages of a downlink multicast or broadcast service may be transmitted through a downlink SCH and may also be transmitted through a downlink multicast channel (MCH). Uplink transport channels for transmission of data from the UE to the network include a Random Access Channel (RACH) for transmission of initial control messages and an uplink SCH for transmission of user traffic or control messages. Logical channels, which are located above the transport channels and are mapped to the transport channels, include a Broadcast Control Channel (BCCH), a Paging Control Channel (PCCH), a Common Control Channel (CCCH), a Multicast Control Channel (MCCH), and a Multicast Traffic Channel (MTCH).

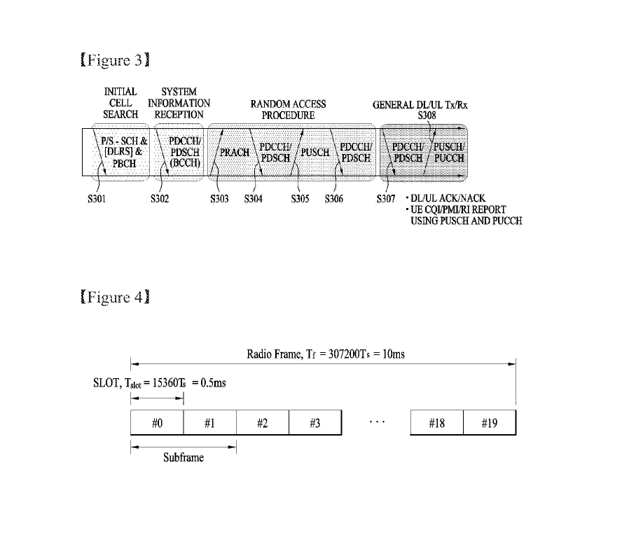

FIG. 3 is a diagram showing physical channels used in a 3GPP system and a general signal transmission method using the same.

A UE performs an initial cell search operation such as synchronization with an eNB when power is turned on or the UE enters a new cell (S301). The UE may receive a Primary Synchronization Channel (P-SCH) and a Secondary Synchronization Channel (S-SCH) from the eNB, perform synchronization with the eNB, and acquire information such as a cell ID. Thereafter, the UE may receive a physical broadcast channel from the eNB so as to acquire broadcast information within the cell. Meanwhile, the UE may receive a Downlink Reference Signal (DL RS) so as to confirm a downlink channel state in the initial cell search step.

The UE, which has completed the initial cell search, may receive a Physical Downlink Control Channel (PDCCH) and a Physical Downlink Shared Channel (PDSCH) according to information included in the PDCCH so as to acquire more detailed system information (S302).

Meanwhile, if the eNB is initially accessed or radio resources for signal transmission are not present, the UE may perform a Random Access Procedure (RACH) (step S303 to S306) with respect to the eNB. In this case, the UE may transmit a specific sequence through a Physical Random Access Channel (PRACH) as a preamble (S303 and S305), and receive a response message of the preamble through the PDCCH and the PDSCH corresponding thereto (S304 and S306). In the case of contention-based RACH, a contention resolution procedure may be further performed.

The UE, which has performed the above procedures, may perform PDCCH/PDSCH reception (S307) and Physical Uplink Shared Channel PUSCH)/Physical Uplink Control Channel (PUCCH) transmission (S308) as a general uplink/downlink signal transmission procedure. In particular, the UE receives downlink control information (DCI) through a PDCCH. Here, the DCI includes control information such as resource allocation information of the UE and the format thereof differs according to the use purpose.

The control information transmitted from the UE to the eNB in uplink or transmitted from the eNB to the UE in downlink includes a downlink/uplink ACK/NACK signal, a Channel Quality Indicator (CQI), a Precoding Matrix Index (PMI), a Rank Indicator (RI), and the like. In the case of the 3GPP LTE system, the UE may transmit the control information such as CQI/PMI/RI through the PUSCH and/or the PUCCH.

FIG. 4 is a diagram showing the structure of a radio frame used in a Long Term Evolution (LTE) system.

Referring to FIG. 4, the radio frame has a length of 10 ms (327200×Tₛ) and includes 10 subframes with the same size. Each of the subframes has a length of 1 ms and includes two slots. Each of the slots has a length of 0.5 ms (15360×Tₛ). Tₛ denotes a sampling time, and is represented by Tₛ=1/(15 kHz×2048)=3.2552×10⁻⁸ (about 33 ns). Each slot includes a plurality of OFDM symbols in a time domain, and includes a plurality of resource blocks (RBs) in a frequency domain. In the LTE system, one RB includes 12 subcarriers×7(6) OFDM or SC-FDMA symbols. A Transmission Time Interval (TTI) which is a unit time for transmission of data may be determined in units of one or more subframes. The structure of the radio frame is only exemplary and the number of subframes included in the radio frame, the number of slots included in the subframe, or the number of OFDM symbols included in the slot may be variously changed.

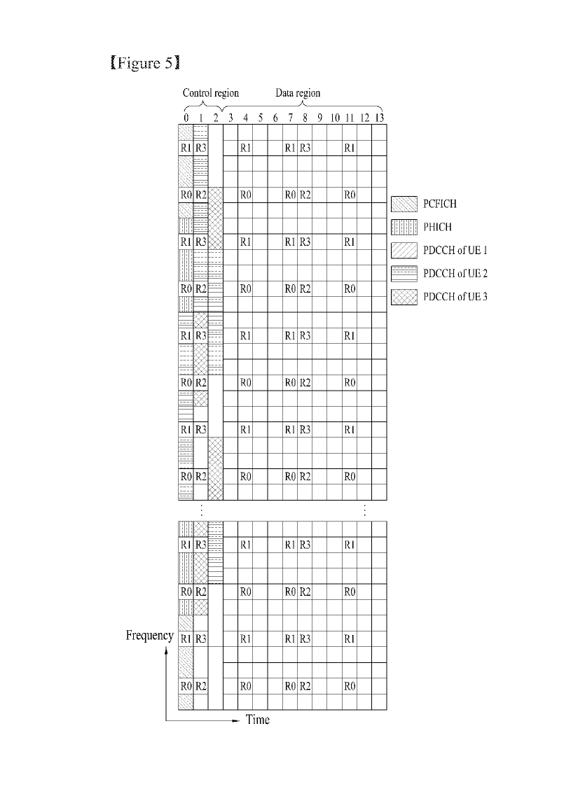

FIG. 5 is a diagram showing a control channel included in a control region of one subframe in a downlink radio frame.

Referring to FIG. 5, a subframe includes 14 OFDM symbols. The first to third OFDM symbols are used as a control region and the remaining 13 to 11 OFDM symbols are used as a data region, according to subframe configuration. In FIG. 5, R1 to R4 denote reference signals (RS) or pilot signals for antennas 0 to 3. The RS is fixed to a constant pattern within a subframe regardless of the control region and the data region. A control channel is allocated to resources, to which the RS is not allocated, in the control region, and a traffic channel is also allocated to resources, to which the RS is not allocated, in the control region. Examples of the control channel allocated to the control region include a Physical Control Format Indicator Channel (PCFICH), a Physical Hybrid-ARQ Indicator Channel (PHICH), a Physical Downlink Control Channel (PDCCH), etc.

The Physical Control Format Indicator Channel (PCFICH) informs the UE of the number of OFDM symbols used for the PDCCH per subframe. The PCFICH is located at a first OFDM symbol and is configured prior to the PHICH and the PDCCH. The PCFICH includes four Resource Element Groups (REGs) and the REGs are dispersed in the control region based on a cell identity (ID). One REG includes four resource elements (REs). The PCFICH has a value of 1 to 3 or 2 to 4 according to bandwidth and is modulated using a Quadrature Phase Shift Keying (QPSK) scheme.

The Physical Hybrid-ARQ Indicator Channel (PHICH) is used to carry HARQ ACK/NACK for uplink transmission. That is, the PHICH refers to a channel via which DL ACK/NACK information for uplink HARQ is transmitted. The PHICH includes one REG and is scrambled on a cell-specific basis. ACK/NACK is indicated by one bit and is modulated using a binary phase shift keying (BPSK) scheme. The modulated ACK/NACK is repeatedly spread with a spreading factor (SF) of 2 or 4. A plurality of PHICHs mapped to the same resources configures a PHICH group. The number of PHICHs multiplexed in the PHICH group is determined according to the number of spreading codes. The PHICH (group) is repeated three times in order to obtain diversity gain in a frequency region and/or time region.

The Physical Downlink Control Channel (PDCCH) is allocated to the first n OFDM symbols of a subframe. Here, n is an integer of 1 or more and is indicated by a PCFICH. The PDCCH includes one or more Control Channel Elements (CCEs). The PDCCH informs each UE or a UE group of information associated with resource allocation of a Paging Channel (PCH) and a Downlink-Shared Channel (DL-SCH), both of which are transport channels, uplink scheduling grant, HARQ information, etc. The paging channel (PCH) and the downlink-shared channel (DL-SCH) are transmitted through a PDSCH. Accordingly, the eNB and the UE transmit and receive data through the PDSCH except for specific control information or specific service data.

Information indicating to which UE (one or a plurality of UEs) data of the PDSCH is transmitted and information indicating how the UEs receive and decode the PDSCH data are transmitted in a state of being included in the PDCCH. For example, it is assumed that a specific PDCCH is CRC-masked with a Radio Network Temporary Identity (RNTI) “A”, and information about data transmitted using radio resource (e.g., frequency location) “B” and transmission format information (e.g., transmission block size, modulation scheme, coding information, or the like) “C” is transmitted via a specific subframe. In this case, one or more UEs located within a cell monitor a PDCCH using its own RNTI information, and if one or more UEs having “A” RNTI are present, the UEs receive the PDCCH and receive the PDSCH indicated by “B” and “C” through the information about the received PDCCH.

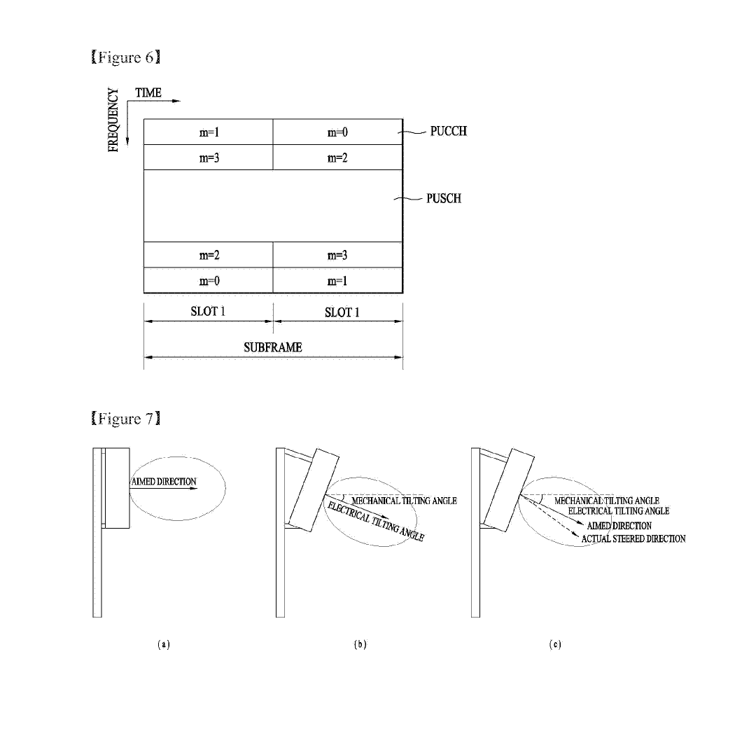

FIG. 6 is a diagram showing the structure of an uplink subframe used in an LTE system.

Referring to FIG. 6, an uplink subframe may be divided into a region to which a Physical Uplink Control Channel (PUCCH) carrying uplink control information is allocated and a region to which a Physical Uplink Shared Channel (PUSCH) carrying user data is allocated. A middle portion of the subframe is allocated to the PUSCH and both sides of a data region in a frequency domain are allocated to the PUCCH. Uplink control information transmitted on the PUCCH includes an ACK/NACK signal used for HARQ, a Channel Quality Indicator (CQI) indicating a downlink channel status, a rank indicator (RI) for MIMO, a scheduling request (SR) which is an uplink radio resource allocation request, etc. The PUCCH for one UE uses one resource block occupying different frequencies in slots within the subframe. Two slots use different resource blocks (or subcarriers) within the subframe. That is, two resource blocks allocated to the PUCCH are frequency-hopped in a slot boundary. FIG. 6 shows the case in which a PUCCH having m=0, a PUCCH having m=1, a PUCCH having m=2, and a PUCCH having m=3 are allocated to the subframe.

Hereinafter, a reference signal (RS) will be described in greater detail.

In general, a transmitter transmits, to the receiver, an RS known to both the transmitter and a receiver along with data so that the receiver may perform channel measurement in the RS. The RS serves to perform demodulation by indicating a modulation scheme as well as channel measurement. The RS is classified into a dedicated RS (DRS) for an eNB and a specific UE, that is, a UE-specific RS, and a common RS (or cell-specific RS (CRS)) for all UEs within a cell. The CRS includes an RS used by a UE to measure a CQI/PMI/RI to be reported to an eNB. This RS is referred to as a channel state information-RS (CSI-RS).

The CSI-RS is proposed for the purpose of channel measurement of a PDSCH independently of a CRS. The CSI-RS may be defined as a maximum of 32 different resource configurations in order to reduce inter-cell interference (ICI) in a multi-cell environment, unlike the CRS.

The CSI-RS (resource) configurations differ according to the number of antenna ports and neighboring cells are configured to transmit CSI-RSs defined as maximally different (resource) configurations. The CSI-RS supports a maximum of 8 antenna ports unlike the CRS. In the 3GPP standard, a total of eight antenna ports, such as antenna ports 15 to 22, is allocated as antenna ports for the CSI-RS.

Hereinafter, channel state information (CSI) report will be described. In the current LTE standard, two transmission schemes, i.e., an open-loop MIMO scheme operating without channel information and a closed-loop MIMO scheme based on channel information exist. In particular, in the closed-loop MIMO scheme, in order to obtain multiplexing gain of a MIMO antenna, an eNB and a UE may perform beamforming based on channel state information. The eNB transmits a reference signal to the UE and instructs the UE to feed back the channel state information measured based thereon via a physical uplink control channel (PUCCH) or a physical uplink shared channel (PUSCH), in order to obtain the channel state information from the UE.

The CSI is roughly divided into a rank indicator (RI), a precoding matrix index (PMI) and a channel quality indicator (CQI). First, the RI indicates the rank information of a channel as described above and means the number of streams which may be received by the UE via the same time-frequency resources. In addition, the RI is determined by long term fading of the channel and thus is fed back to the eNB at a period longer than that of the PMI or CQI.

Second, the PMI has a channel space property and indicates a precoding matrix index of the eNB preferred by the UE based on a metric such as a signal to interference plus noise ratio (SINR). Lastly, the CQI indicates the intensity of the channel and means a reception SINR obtained when the eNB uses the PMI.

In an evolved communication system such as LTE-A standard, obtaining additional multi-user diversity using multi-user MIMO (MU-MIMO) was added. In MU-MIMO, since interference is generated between UEs multiplexed in an antenna domain, accuracy of the CSI may influence not only a UE, which has reported the CSI, but also interference of the other multiplexed UEs. Accordingly, in MU-MIMO, a more accurate CSI report is required as compared to SU-MIMO.

Hereinafter, an active antenna system (AAS) and three-dimensional (3D) beamforming will be described.

In an existing cellular system, a base station has used a method for reducing inter-cell interference (ICI) using mechanical tilting or electrical tilting and improving throughput, e.g., signal to interference plus noise ratios (SINRs), of UEs of a cell, which will be described in greater detail with reference to the drawings.

FIG. 7 is a diagram illustrating an antenna tilting method. In particular, FIG. 7(a) shows an antenna structure to which antenna tilting is not applied, FIG. 7(b) shows an antenna structure to which mechanical tilting is applied, and FIG. 8(c) shows an antenna structure to which both mechanical tilting and electrical tilting are applied.

In comparison of FIG. 7(a) with FIG. 7(b), when mechanical tilting is applied, a beam direction is fixed upon initial installation as shown in FIG. 7(b). Further, when electrical tilting is applied, as shown in FIG. 7(c), a tilting angle may be changed using an internal phase shift module but only restrictive vertical beamforming is possible due to fixed tilting.

FIG. 8 is a diagram showing comparison between an existing antenna system and an active antenna system. In particular, FIG. 8(a) shows an existing antenna system and FIG. 8(b) shows an active antenna system.

Referring to FIG. 8, unlike the existing antenna system, the active antenna system is characterized in that power and phase adjustment of each antenna module is possible because each of a plurality of antenna modules includes a RF module including a power amplifier, that is, an active element.

As a general MIMO antenna structure, a linear antenna array, that is, one-dimensional antenna array, such as a uniform linear array (ULA), was considered. In the one-dimensional array structure, beams which may be formed by beamforming are present in a two-dimensional plane. This is applied to a passive antenna system (PAS)-based MIMO structure of an existing base station. Although vertical antennas and horizontal antennas are present even in a PAS based base station, the vertical antennas are fixed to one RF module and thus beamforming is impossible in a vertical direction and only mechanical tilting is applicable.

However, as an antenna structure of a base station has evolved to an active antenna system, independent RF modules may be implemented in vertical antennas and thus beamforming is possible not only in a horizontal direction but also in a vertical direction. This is referred to as vertical beamforming or elevation beamforming.

According to vertical beamforming, since formable beams may be expressed in three-dimensional space in vertical and horizontal directions, vertical beamforming may be referred to as three-dimensional beamforming. That is, three-dimensional beamforming becomes possible by evolution from a one-dimensional antenna array structure to a two-dimensional planar antenna array structure. Three-dimensional beamforming is possible not only in a planar antenna array structure but also in a ring-shaped three-dimensional array structure. Three-dimensional beamforming is characterized in that a MIMO process is performed in a three-dimensional space because various antenna structures may be used in addition to the one-dimensional antenna array structure.

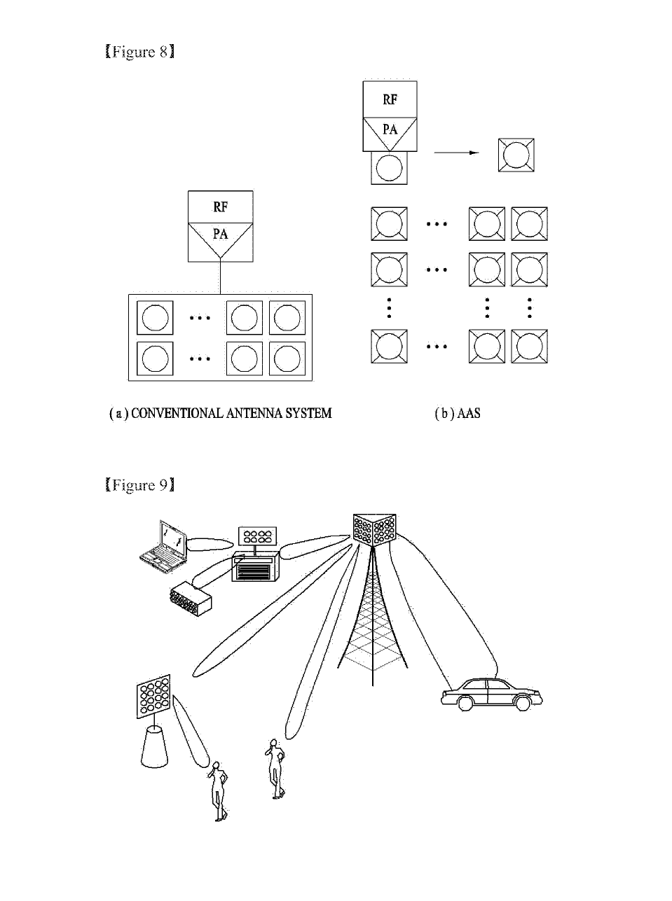

FIG. 9 is a diagram showing an example of forming a UE-specific beam based on an active antenna system. Referring to FIG. 9, due to three-dimensional beamforming, beamforming is possible not only when a UE moves from side to side but also when a UE moves back and forth, thereby providing a higher degree of freedom to UE-specific beamforming.

Further, as a transmission environment using a two-dimensional antenna array structure based on an active antenna, an environment in which an outdoor eNB transmits a signal to an outdoor UE, an environment in which an outdoor eNB transmits a signal to an indoor UE (outdoor to indoor; O2I) and an environment in which an indoor eNB transmits a signal to an indoor UE (indoor hotspot) may be considered.

FIG. 10 is a diagram showing a 3-dimensional (3D) beam transmission scenario based on an active antenna system.

Referring to FIG. 10, in an actual cell environment in which a plurality of buildings is present per cell, an eNB needs to consider vertical beam steering capabilities considering various UE heights due to building heights as well as UE-specific horizontal beam steering. In such a cell environment, channel properties different from those of an existing radio channel environment, e.g., shadow/path loss change due to height difference, fading property change, etc. need to be applied.

In other words, thee-dimensional beamforming is evolved from horizontal beamforming based on a one-dimensional linear antenna array structure and refers to a MIMO processing scheme which is an extension to or a combination with elevation beamforming or vertical beamforming based on an antenna structure of a multi-dimensional array, such as a planar antenna array, or a massive antenna array.

The massive antenna array has one or more of the following characteristics. That is, i) the massive antenna array is located on a two-dimensional (2D) plane or in a 3D space, ii) the number of logical or physical antennas is eight or more (here, the logical antenna may be expressed by an antenna port) and iii) each antenna is composed of an AAS. However, definition of the massive antenna array is not limited thereto. Hereinafter, various beamforming schemes using a massive antenna array will be described.

a) Partial antenna array based beamforming applied to a 3D beamforming environment is referred to as beam-width adaptation (BA) beamforming, which has the following features.

In the BA beamforming scheme, the number of antennas participating in data transmission is adjusted according to the speed of a UE to adjust a transmission beam width.

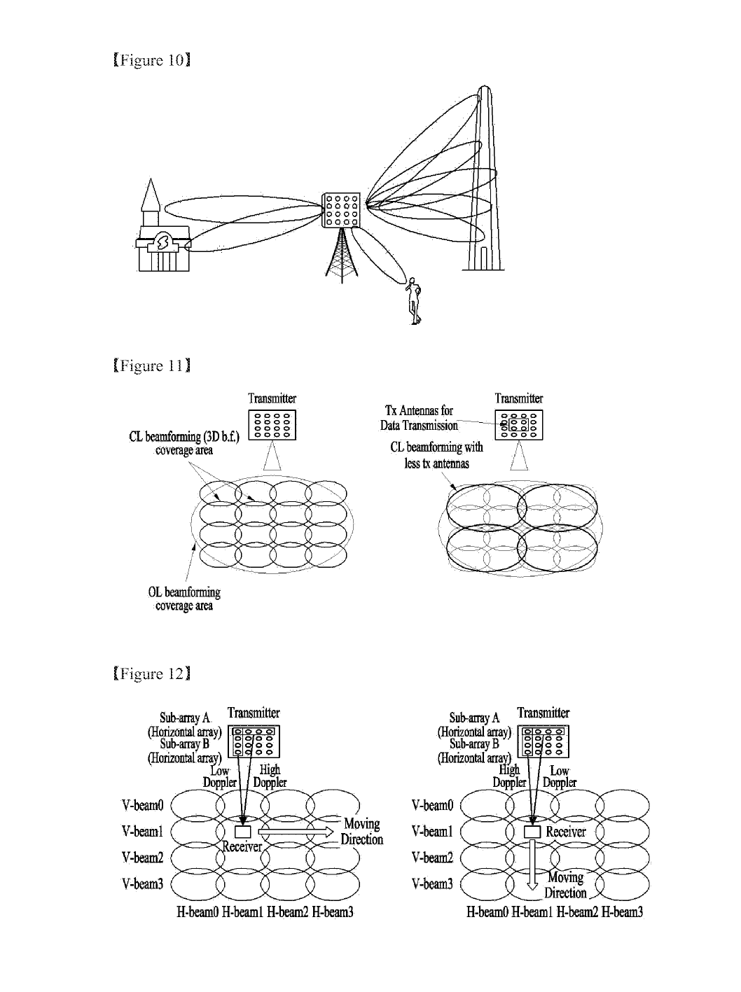

FIG. 11 is a diagram showing comparison in beam coverage between an existing MIMO transmission scheme and a BA beamforming scheme. In particular, the left side of FIG. 11 shows the existing MIMO transmission scheme and the right side thereof shows the BA beamforming scheme.

Referring to the left side of FIG. 11, in a 4×4 antenna array, if a UE moves at a medium speed, the width of a beam transmitted by the 4×4 antenna array is too narrow to obtain channel accuracy. Since an open-loop scheme covers whole cell coverage, the beam width may be excessively wide. As shown in the right side of FIG. 11, if only two 2×2 central antenna arrays participate in transmission, a beam having a relatively wide beam width and capable of obtaining beam gain may be generated. That is, the number of antennas participating in transmission to the UE is reduced according to the speed of the UE to increase the beam width, thereby acquiring beam gain lower than that of closed-loop beamforming but higher than that of open-loop beamforming.

b) If the beam width is adjusted according to mobility of the UE in the BA beamforming scheme, a method for performing beamforming in a vertical or horizontal direction according to the movement direction of the UE and performing open loop precoding may also be considered. This technology is referred to as dimension adaptation (DA) beamforming because 2D beamforming may be performed in a 3D beamforming environment.

The DA beamforming scheme is a beamforming scheme for, at an eNB, applying an open-loop scheme to the direction, in which movement of the UE is big, that is, the direction, in which the Doppler effect is high, of the vertical direction and the horizontal direction and applying a closed-loop scheme to the other direction.

FIG. 12 is a diagram showing the concept of a DA beamforming scheme. In particular, the left side of FIG. 12 shows the case in which a UE moves in a horizontal direction and the right side thereof shows the case in which a UE moves in a vertical direction.

FIG. 13 is a diagram showing the features of a DA beamforming scheme.

If a DA beamforming scheme is used, beam gain can be obtained in a direction in which the Doppler effect is low but cannot be obtained in a direction in which the Doppler effect is high. Accordingly, in an area in which a beam is generated, a beam having a narrow width is generated in one of a horizontal direction and a vertical direction as shown in FIG. 13. Accordingly, it is possible to provide beam gain having a predetermined level to a UE moving in a specific direction.

c) Dimension and beam-width adaptation (DBA) which is a combination of a BA beamforming scheme and a DA beamforming scheme may also be considered.

FIG. 14 is a diagram showing the concept of a DBA beamforming scheme.

The DBA beamforming scheme is a combination of a DA beamforming scheme and a BA beamforming scheme. Referring to FIG. 14, if a UE moves in a vertical or horizontal direction upon applying the DBA beamforming scheme, closed-loop beamforming is performed in a direction in which the Doppler effect is low, that is, in a direction orthogonal to movement of a UE, and the number of antennas participating in transmission is adjusted according to the speed of the UE to adjust a beam width in a direction in which the Doppler effect having a predetermined level is present.

In summary, as shown in Table 1, the DA beamforming scheme is suitable when a UE moves at a high speed in a specific direction with respect to an eNB, the BA beamforming scheme is suitable when a UE moves at a low speed or a medium speed, and the DBA beamforming scheme is suitable when a UE moves in a specific direction at a low speed or a medium speed.

TABLE 1

| | |
|---|---|
| Dimension adaptation (DA) | A UE moves at a high speed in a vertical |
| beamforming | or horizontal direction with respect to an |
| | eNB. |
| Beam-width adaptation | Low-speed or medium-speed movement |
| beamforming | environment |
| DBA beamforming (DA + | A UE moves in a vertical or horizontal |
| BA) | direction with respect to an eNB at a low |
| | speed or a medium speed. |

In order to adaptively apply a beamforming scheme such as a DA/BA/DBA beamforming scheme according to channel variation, it is important to check whether a channel between an eNB and a UE is rapidly varied. In particular, for DA beamforming or DBA beamforming, both channel variation in a vertical direction and channel variation in a horizontal direction should be checked. The present invention proposes a method for measuring channel variation.

Based on the above discussion, a feedback method for 3D MIMO of the present invention will be described. In particular, the present invention proposes a feedback information configuration and a UE feedback calculation method for integral operation of open-loop MIMO, closed-loop MIMO and DA beamforming, BA beamforming and DBA beamforming.

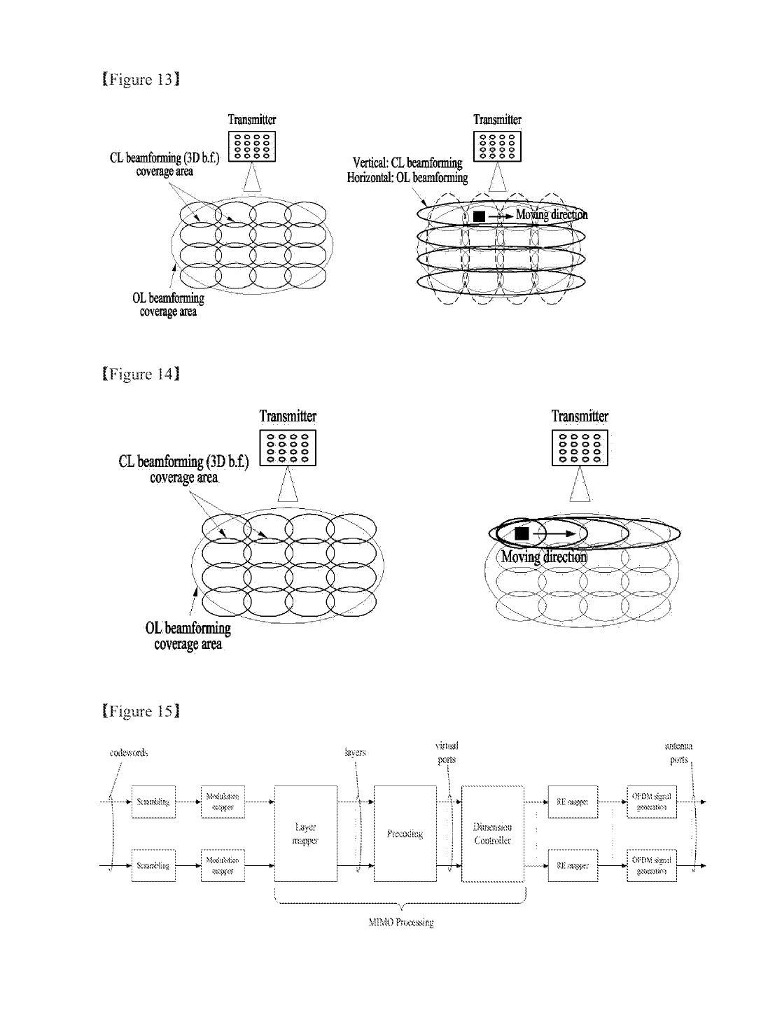

In the present invention, a downlink MIMO transmission structure shown in FIG. 15 is assumed.

FIG. 15 is a diagram showing the concept of a downlink MIMO transmission structure according to an embodiment of the present invention.

Hereinafter, assume that a total number of transmission layers is M, a total number of CSI-RS antenna ports is Nc, and a total number of virtual antenna ports is Nx. In addition, if an eNB is composed of a 2D antenna array, a total number of CSI-RS antenna ports transmitted in an antenna row direction is Nc_h and a total number of CSI-RS antenna ports transmitted in an antenna column direction is Nc_v. Additionally, the numbers of antenna ports controlled by a dimension controller are denoted by Nx_h and Nx_v in row and column directions.

The dimension controller maps Nc CSI-RS antenna ports or channel measurement reference signal antenna ports (hereinafter, referred to as eCSI-RS antenna ports) corresponding thereto to Nx virtual antenna ports.

In the case of a 2D antenna array, Nc_h eCSI-RS antenna ports are mapped to Nx_h horizontal virtual antenna ports and Nc_v eCSI-RS antenna ports are mapped to Nx_v vertical virtual antenna ports.

For example, the dimension controller may configure an Nc_h×Nx_h matrix D_h in a horizontal direction and an Nc_v×Nx_v matrix D_v in a vertical direction as shown in Equations 1 and 2 below.

$$\begin{matrix}D\_h ( Nc\_h , Nx\_h ) = \frac{\sqrt{Nc\_h}}{\sqrt{Nx\_h}} [ \begin{matrix}{I}_{Nx \_ h , Nx \_ h} \\ {0}_{( Nc \_ h - Nx \_ h ) , Nx \_ h}\end{matrix} ] & [ Equation 1 ] \\ D\_v ( Nc\_v , Nx\_v ) = \frac{\sqrt{Nc\_v}}{\sqrt{Nx\_v}} [ \begin{matrix}{I}_{Nx \_ v , Nx \_ v} \\ {0}_{( Nc \_ v - Nx \_ v ) , Nx \_ v}\end{matrix} ] & [ Equation 2 ]\end{matrix}$$

In Equations 1 and 2 above, I_{m,m} denotes a m×m unit matrix 0_{n,m} denotes an n×m zero matrix. Although the Nx_h and Nx_v values use values reported by the UE to the eNB, the eNB may correct or arbitrarily set the values.

For reference, a 3D MIMO precoding scheme may be calculated in the following embodiment.

1) A precoding vector uᵢ for an i-th transmission layer is composed of a Kronecker product of a horizontal precoding vector cᵢ and a vertical precoding vector rᵢ as shown in Equation 3 below.

uᵢ=rᵢ [symbol] cᵢ Equation 3

2) A MIMO precoder for all transmission layers is composed of a Khatri-Rao product (column-wise Kronecker product) of a horizontal precoding matrix C and a horizontal precoding matrix R as shown in Equation 4 below. Here, the size of the horizontal precoding matrix C is Nxₕ×M and the size of the horizontal precoding matrix R is Nx_v×M.

U=[r₁ [symbol] c₁ . . . r_{M} [symbol] c_{M}]=R*C Equation 4

In this case, the feedback configuration method according to the embodiment of the present invention will be described.

A PMI value including a vertical PMI (V-PMI) and a horizontal PMI (H-PMI) is fed back. The CSI feedback information configuration according to transmission mode is shown in Table 2 below.

TABLE 2

| Transmission mode | CSI feedback information configuration |
|---|---|
| Open loop | CQI, RI, (Nx_v, Nx_h)¹⁾ |
| Closed loop | V-PMI, H-PMI, CQI, RI, Nx_v, Nx_h, (A-PMI)²⁾ |
| V-only | V-PMI, CQI, RI, Nx_v, (Nx_h)¹⁾ |
| beamforming | |
| H-only | H-PMI, CQI, RI, Nx_h, (Nx_v)¹⁾ |
| beamforming | |

In Table 2 above, an item denoted by 1) may be omitted when an eNB specifies a transmission mode. For example, if each transmission mode is individually specified by the eNB, the item denoted by 1) may be omitted upon configuring feedback information according to transmission mode.

In contrast, if the above-described transmission modes are flexibly applied within a single transmission mode, the items may be included. For example, information may be composed of Nx_v=C and Nx_h=C if a UE prefers OL MIMO transmission, may be composed of Nx_h=C if a V-only beamforming is preferred, and may be composed of Nx_v=C if H-only beamforming is preferred. Here, the C value means that open-loop MIMO transmission is preferred in the corresponding direction, is predetermined between the eNB and the UE, and may be any value out of a range of 2 to Nc_i (where, i=h or v). For example, C=1 or 100.

In addition, information Nx_v and Nx_h may be formatted in other information. For example, a new index x may be defined according to the range of Nx_i (where, i is v or h) preferred by the UE. For example, if x is 1, Nx_i=1 to 2 and, if x is 2, Nx_i=3 to 5.

In addition, an item denoted by 2) means an A-PMI (Augmented PMI), which will be described below.

When the UE receives an eCSI-RS based eCSI process, that is, eCSI based a feedback configuration, the following procedure is performed.

(1) Step 1: Dimension Decision

The UE acquires information Nc, Nc_h and Nc_v from eCSI process configuration information and estimates vertical and horizontal channels based on an eCSI-RS. In addition, based on the estimated channel information, in consideration of UE mobility, optimal Nx_v and Nx_h values are found. Therefrom, dimension controllers D_h and D_v are decided. If the Nx_v value or the Nx_h value is C, step 2a is performed and, otherwise, step 2b is performed.

(2) Step 2a: PMI/RI Calculation

For j corresponding to Nx_j=C, a j-PMI/j-RI is decided by applying a predetermined open loop MIMO scheme (e.g., PMI cycling). For j corresponding to Nx_j≠C, a corresponding channel is multiplied by D_J and then a j-PMI/j-RI is decided from a PMI codebook.

(3) Step 2b: Initial PMI/RI Calculation

The horizontal channel estimated in step 1 is multiplied by D_h and then an H-PMI/H-RI is decided. Similarly, the vertical channel estimated in step 1 is multiplied by D_v and then a V-PMI/V-RI is set.

(4) Step 3: RI Decision

The RI is decided by a specific function value of the V-RI and the H-RI obtained in step 1. For example, the RI may be max(V-RI, H-RI) or min(V-RI, H-RI).

(5) Step 4: PMI Re-Calculation

The j-PMI of the V-PMI and the H-PMI, the size of which does not match that of the RI decided in step 3, is re-calculated after the RI value is fixed to the value decided in step 3. Alternatively, an A-PMI corresponding to a difference between the RI value and j-PMI (e.g., RI−j-RI) is obtained. For example, the A-PMI may be composed of a matrix having a size of Nx_j×(RI−j-RI).

(6) Step 5: CQI Calculation

A CQI value is calculated based on a precoding matrix calculated based on the V-PMI, H-PMI and RI decided in steps 1 to 4.

The method of estimating the vertical and horizontal channels based on the eCSI-RS in step 1 may vary according to CSI-RS resource transmission method, which will be described with reference to the drawings.

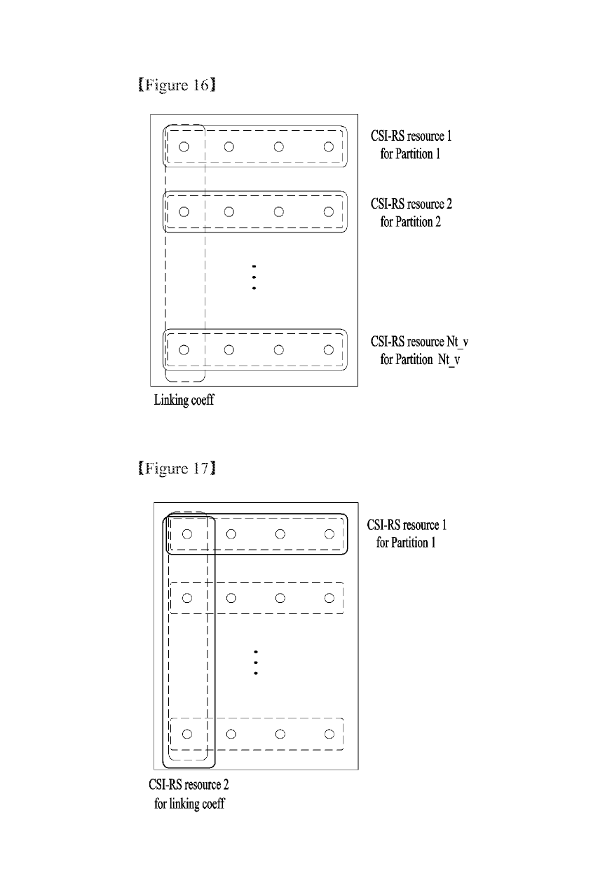

FIGS. 16 and 17 are diagrams showing examples of configuring CSI-RS resources configuring an eCSI-RS according to an embodiment of the present invention.

As shown in FIG. 16, if a plurality of CSI-RS resources is transmitted, an average value of channels measured from CSI-RS resources configuring the eCSI-RS is a horizontal channel and a phase difference between the channels estimated from the CSI-RS resources is a vertical channel. However, if a plurality of CSI-RS resources is transmitted as shown in FIG. 17, two CSI-RS resources configuring the eCSI-RS correspond to a horizontal channel and a vertical channel, respectively.

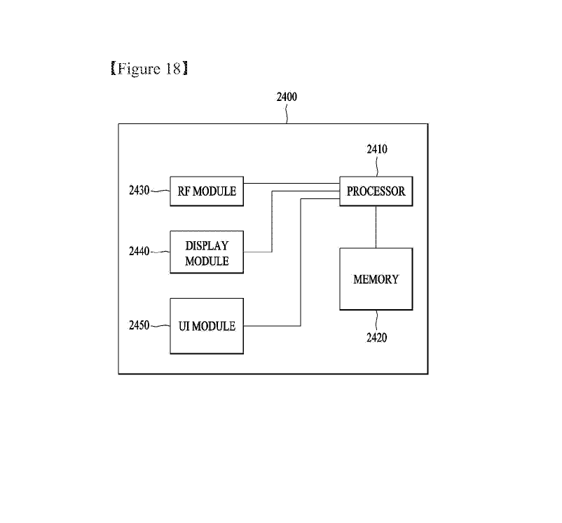

FIG. 18 is a block diagram of a communication apparatus according to one embodiment of the present invention.

Referring to FIG. 18, a communication apparatus 2400 includes a processor 2410, a memory 2420, a Radio Frequency (RF) module 2430, a display module 2440 and a user interface module 2450.

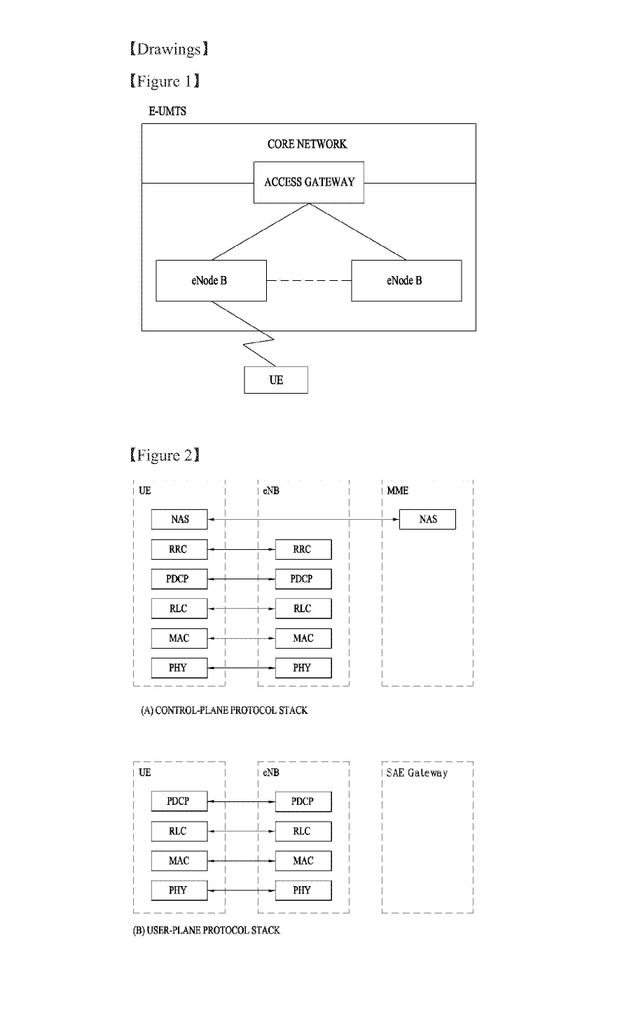

The communication apparatus 2400 is shown for convenience of description and some modules thereof may be omitted. In addition, the communication apparatus 2400 may further include necessary modules. In addition, some modules of the communication apparatus 2400 may be subdivided. The processor 2410 is configured to perform an operation of the embodiment of the present invention described with reference to the drawings. For a detailed description of the operation of the processor 2410, reference may be made to the description associated with FIGS. 1 to 17.

The memory 2420 is connected to the processor 2410 so as to store an operating system, an application, program code, data and the like. The RF module 2430 is connected to the processor 24010 so as to perform a function for converting a baseband signal into a radio signal or converting a radio signal into a baseband signal. The RF module 2430 performs analog conversion, amplification, filtering and frequency up-conversion or inverse processes thereof. The display module 2440 is connected to the processor 2410 so as to display a variety of information. As the display module 2440, although not limited thereto, a well-known device such as a Liquid Crystal Display (LCD), a Light Emitting Diode (LED), or an Organic Light Emitting Diode (OLED) may be used. The user interface module 2450 is connected to the processor 2410 and may be configured by a combination of well-known user interfaces such as a keypad and a touch screen.

The above-described embodiments are proposed by combining constituent components and characteristics of the present invention according to a predetermined format. The individual constituent components or characteristics should be considered optional on the condition that there is no additional remark. If required, the individual constituent components or characteristics may not be combined with other components or characteristics. In addition, some constituent components and/or characteristics may be combined to implement the embodiments of the present invention. The order of operations disclosed in the embodiments of the present invention may be varied. Some components or characteristics of any embodiment may also be included in other embodiments, or may be replaced with those of the other embodiments as necessary. Moreover, it will be apparent that some claims referring to specific claims may be combined with other claims referring to the other claims other than the specific claims to constitute the embodiment or add new claims by means of amendment after the application is filed.

In this document, a specific operation described as performed by the BS may be performed by an upper node of the BS. Namely, it is apparent that, in a network comprised of a plurality of network nodes including a BS, various operations performed for communication with a UE may be performed by the BS, or network nodes other than the BS. The term BS may be replaced with the terms fixed station, Node B, eNode B (eNB), access point, etc.

The embodiments of the present invention can be implemented by a variety of means, for example, hardware, firmware, software, or a combination thereof. In the case of implementing the present invention by hardware, the present invention can be implemented through application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. The software code may be stored in a memory unit so as to be driven by a processor. The memory unit may be located inside or outside of the processor, so that it can communicate with the aforementioned processor via a variety of well-known parts.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

Although an example of applying a feedback report method and apparatus for three-dimensional (3D) beamforming in a wireless communication system to a 3GPP LTE system is described, the present invention is applicable to various wireless communication systems in addition to the 3GPP LTE system. In addition, although the present invention relates to a massive antenna, the present invention is applicable to other antenna structures.

1. (canceled)

2. A method of transmitting feedback information to a base station by a user equipment in a wireless communication system, the method comprising:
receiving information about reference signals;
measuring channels using the reference signals;
determining sizes of precoders, based on the measured channels,
transmitting the feedback information including the sizes of the precoders,
wherein, if at least one of the sizes of precoders has a predefined value, an open loop transmission mode is applied to corresponding channel.

3. The method of claim 2, wherein the reference signals comprise a first reference signal for a horizontal channel and a second reference signal for a vertical channel.

4. The method of claim 2, wherein the feedback information includes a preferred precoder for a channel to which the open loop transmission mode is not applied.

5. The method of claim 2, wherein the sizes of precoders are determined using mobility of the user equipment.

6. A method of receiving feedback information from a user equipment by a base station in a wireless communication system, the method comprising:
transmitting information about reference signals; and
receiving the feedback information including sizes of precoders,
wherein the sizes of precoder is determined based on channels corresponding to the reference signals
wherein, if at least one of the sizes of precoders has a predefined value, an open loop transmission mode is applied to corresponding channel.

7. The method of claim 6, wherein the reference signals comprise a first reference signal for a horizontal channel and a second reference signal for a vertical channel.

8. The method of claim 6, wherein the feedback information includes a preferred precoder for a channel to which the open loop transmission mode is not applied.

9. The method of claim 6, wherein the sizes of precoders are determined using mobility of the user equipment.
